(19) United States
(12) Patent Application Publication
(10) Pub. No.: US 2026/0172853 A1
(43) Pub. Date: Jun. 18, 2026

(54) Dynamic Network Management Using Wireless Metric Messages

(71) Applicant: Nova Labs Inc., San Francisco, CA (US)

(72) Inventors: Joseph Padden, Boulder, CO (US); Mario Di Dio, Longmont, CO (US); Oleksandr Berezovskyi, Kharkiv (UA); Roman Skochypets, Kyiv (UA); Serhii Tukalo, Kyiv (UA)

(21) Appl. No.: 19/421,670

(22) Filed: Dec. 16, 2025

Related U.S. Application Data
(60) Provisional application No. 63/735,292, filed on Dec. 17, 2024.

(51) Int. Cl. H04W 24/02; H04B 17/318; H04W 12/06; H04W 64/00

(52) U.S. Cl. CPC H04W 24/02; H04B 17/318; H04W 12/06; H04W 64/003

(57) ABSTRACT

Methods and systems for dynamically improving wireless access point performance are described herein. A server may receive, from one or more wireless access points, strings indicating metrics corresponding to performance, by a wireless access point, when providing a wireless network. These strings might be included in existing protocol communications between the server and the access point, thereby avoiding the need for additional communications processes. Operating parameter changes may be identified based on the metrics, and the server may cause the wireless access points to make those changes. This may include causing devices using the wireless network(s) to prioritize a particular wireless access point, prompting an owner of the wireless access point to relocate the wireless access point to avoid certain objects, and/or causing one or more different wireless access points to refuse connections with certain devices.

### FIELD

Aspects described herein generally relate to computer networking, wireless networks, management of wireless access points, and the like. More specifically, one or more aspects describe herein provide for dynamically improving wireless access point performance based on metric messages transmitted by wireless access points.

### BACKGROUND

Though common, wireless networks (such as wireless networks provided in compliance with the 802.11 wireless networking standards) can be very rudimentary in terms of their implementation. Typically, an entity purchasing a wireless access point (such as a wireless router, which might be part of their internet modem) installs the wireless access point at a convenient (and, often, hidden) location in their home or office and, beyond setting up a wireless network name and/or password, pays very little attention to the configuration of that wireless access point. This approach may be sufficient for most users: after all, if the wireless access point is strong enough to substantially reach most locations in their home or office, they rarely have any reason to dive into complicated network configuration processes.

In recent years, it has become increasingly popular for user-managed devices to provide public access to the Internet or other networks. For instance, some wireless routers (e.g., those that might be installed in stores, homes, coffee shops) are configured to expose a public (and, often, Internet Service Provider (ISP)-branded) wireless network that is accessible to customers of the ISP using their individual login credentials. As another example, individuals might purchase wireless access points and deploy wireless networks for public use in exchange for renumeration (in, e.g., fiat and/or cryptocurrency) for that service. In such circumstances, higher-order management (e.g., by an ISP or other third party) of these devices can be extremely difficult. After all, even when incentivized to do so, owners of those devices are rarely equipped to locate and configure the wireless access points to maximize their usefulness, instead often taking the standard “fire and forget” approach that they would with their own personal wireless routers. This often means that these public-facing wireless access points are sub-optimally configured in terms of, among other things, their location, the channel(s) that they use, their signal strength, and the like.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed towards dynamically improving wireless access point performance. As will be detailed below, this process involves configuring certain wireless access points to transmit messages comprising strings that represent a variety of performance metrics of those wireless access points. These messages might be included in pre-existing communications between those wireless access points and a head-end server (e.g., via Remote Authentication Dial-In User Service (RADIUS) networking protocol messages), thereby enabling even relatively rudimentary wireless access points to perform such messaging. In this manner, a head-end server may receive, from a variety of different wireless access points in various geographic locations, messages reflecting the performance of those different wireless access points over time. This information may be used to grade these wireless access points in terms of their performance: for instance, the head-end server might grade different wireless access points with letter grades from “A” to “F,” reflecting their relative performance compared to, for example, other wireless access points and/or a minimum service standard. Moreover, such grading might be based on metrics from other wireless access points: for example, the metrics from two different wireless access point in the same geographic region may suggest that one wireless access point is best positioned to handle one subset of that geographic region, whereas the other wireless access point is best positioned to handle the other subset of that geographic region. However calculated, based on this information, the head-end server might take a variety of steps to improve the end user experience on wireless networks provided by wireless access points. For instance, the head-end server might instruct one or more wireless access points in a geographic region to deny connection requests from user equipment (e.g., laptops, smartphones), thereby gently guiding that user equipment to connect to a preferred wireless access point that is predicted to provide better connectivity. As another example, the head-end server might identify a user device of an owner of a particular wireless access point and prompt them to move the wireless access point using a map that guides them to move the wireless access point from one physical location to another.

To provide an example of how this process might perform in real-world conditions, there may be two wireless access points: one located in a first restaurant in a strip mall, and another located in an adjoining restaurant in the same strip mall. With that said, metrics transmitted by one of those wireless access points (as included in strings, as indicated above) may indicate that it has an extremely high level of traffic (e.g., fifteen thousand active users over a two-week period), but that the vast majority of those connecting to the wireless access point had a low quality experience (that is, their connection was slow, unreliable, or otherwise unsatisfactory). This may indicate some poor performance on the part of the wireless access point due to its operating parameters (e.g., its transmission strength may be too low) and/or due to its location (e.g., it may be blocked by a large metal object, such as a range hood in the restaurant, effectively impeding signals to user devices). In turn, the processes described herein can help improve the wireless access point's performance by, for example, transmitting, to a user device associated with an owner of the restaurant, a prompt to relocate the wireless access point to a new location (e.g., one not blocked by the range hood). The operating parameters (e.g., transmission strength) of that wireless access point may also be automatically modified for better performance. That said, in addition to such steps, the other wireless access point (that is, the other wireless access point in the other restaurant) might also be modified. For instance, changes to the operating parameters of one wireless access point might trigger corresponding changes in the other, and/or the owner of the other wireless access point might be prompted to move that wireless access point as well. In turn, two entirely different wireless access points on two properties and with two entirely different owners can be optimized in a manner that provides ideal performance to users of these wireless access points. These sorts of improvements may be ideal for all parties, particularly where the owners of both restaurants are incentivized (e.g., compensated) for use of these wireless access points, as such modifications ensure that more users are likely to use their connections and that the connections they use have a far better quality.

As a more particularized example of the processes described in more detail below, a server may be configured to dynamically improve wireless access point performance. This may comprise receiving, by the server and from a first wireless access point, a first string indicating a first set of metrics corresponding to performance, by the first wireless access point, when providing a first wireless network in a geographic region. The server might identify that first set of metrics by, for example, splitting the first string into a plurality of different portions and by correlating each of the plurality of different portions of the string to a different metric of the first set of metrics. The server may then identify, based on comparing the first set of metrics to a grading standard (e.g., one or more rules for offloading, based on metric measurements, connected user devices), one or more operating parameter changes for the first wireless access point, and transmit, to the first wireless access point, instructions configured to cause the first wireless access point to implement the one or more operating parameter changes. Then, the server may receive, from the first wireless access point, a second string indicating an updated plurality of metrics corresponding to performance, by the first wireless access point, when providing the first wireless network in the geographic region. In turn, the server may cause, based on the updated plurality of metrics, a first user device to prioritize wireless connectivity via the first wireless network over one or more second wireless networks in the geographic region.

The string(s) received by the server may comprise alphanumeric strings that concatenate various performance metrics for a wireless access point. For example, the strings might concatenate two or more of a Received Signal Strength Indicator (RSSI), downstream bit rate, upstream bit rate, channel utilization, frame loss, and/or latency. That alphanumeric string might be included in preexisting protocol messages, such as messages transmitted as part of the RADIUS networking protocol.

The server may be configured to cause user devices, such as the first user device, to prioritize wireless connectivity via a first wireless network over one or more second wireless networks in a geographic region in a variety of ways, including using indirect means that do not involve direct transmissions to the user devices. For example, the server may transmit, to one or more second wireless access points providing the one or more second wireless networks in the geographic region, second instructions configured to cause the one or more second wireless access points to deny connection requests from one or more user devices.

The server may consider metrics from a variety of different time points when determining operating parameter changes for a particular wireless access point. For example, the server may receive, from the first wireless access point, one or more second strings indicating a plurality of different sets of metrics corresponding to performance, by the first wireless access point, when providing the first wireless network in the geographic region at different times, and then may calculate, based on the first set of metrics and the plurality of different sets of metrics, a performance trend of the first wireless access point. In that circumstance, the server might determine one or more operating parameter changes for a first wireless access point further based on that performance trend.

The server may consider metrics from a wide variety of different wireless access points when determining operating parameter changes for a particular wireless access point. For example, the server may receive, from one or more second wireless access points providing the one or more second wireless networks in the geographic region, a plurality of second strings indicating a plurality of sets of second metrics corresponding to performance, by the one or more second wireless access points, when providing one or more second wireless networks in the geographic region. In that circumstance, the server might determine one or more operating parameter changes for a first wireless access point further based on the plurality of sets of second metrics.

One of the many advantages of the aspects described herein is that control of multiple different wireless access points may be effectuated to optimize wireless network connectivity in a geographic region. For example, the head-end server may be configured to dynamically assign regions to wireless access points. The server may receive, from a first wireless access point, a first string indicating a first set of metrics corresponding to performance, by the first wireless access point, when providing a first wireless network in a geographic region. The server may also receive, from a second wireless access point providing a second wireless network in the geographic region, a second string indicating a second set of second metrics corresponding to performance, by the second wireless access point, when providing the second wireless network in the geographic region. The server may then compare, based on the first set of metrics and the second set of second metrics, performance of the first wireless access point and the second wireless access point. Based on that comparing, the server may cause the first wireless access point to provide wireless connectivity via the first wireless network within a first portion of the geographic region and reject wireless connectivity via the first wireless network within a second portion of the geographic region. Moreover, based on that comparing, the server may cause the second wireless access pint to provide wireless connectivity via the second wireless network within the second portion of the geographic region and reject wireless connectivity via the second wireless network within the first portion of the geographic region.

One of the many advantages of the aspects described herein is that they may be used to prompt owners of wireless access points to move those wireless access points to locations that may improve the performance of those wireless access points. For example, the server may be configured to receive, from a first wireless access point, a first string indicating a first set of metrics corresponding to performance, by the first wireless access point, when providing a first wireless network in a geographic region. The server may then identify a first physical location of the first wireless access point, predict, based on the first physical location of the first wireless access point and based on the first set of metrics, one or more impediments to signals transmitted by the first wireless access point, and then identify, based on the predicted one or more impediments to signals transmitted by the first wireless access point, a second physical location. The server may then transmit, to a first user device associated with an owner of the first wireless access point, instructions to move a physical location of the first wireless access point from the first physical location to the second physical location. Then, the server may receive, from the first wireless access point and based on a determination that the first wireless access point has been moved from the first physical location to the second physical location, a second string indicating an updated plurality of metrics corresponding to performance, by the first wireless access point, when providing the first wireless network in the geographic region. The server may then cause, based on the updated plurality of metrics, a second user device to prioritize wireless connectivity via the first wireless network over one or more second wireless networks in the geographic region.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture.

FIG. 3A depicts an example of a first system involving wireless access points and user devices.

FIG. 3A depicts a second example of a first system involving wireless access points and user devices, where one wireless access point has been moved.

FIG. 4 comprises a flowchart depicting an illustrative method for dynamically improving wireless access point performance.

FIG. 5 comprises a flowchart depicting an illustrative method for dynamically assigning regions to wireless access points.

FIG. 6 comprises a flowchart depicting an illustrative method for improving locations of movable wireless access points.

FIG. 7 depicts a chart of wireless access point grades versus connection quality.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, individuals might install wireless access points in their premises for private purposes (e.g., to provide wireless connectivity to their own devices) as well as public purposes (e.g., to provide wireless connectivity to the general public as part of an agreement with their ISP and/or in exchange for some form of payment). Such individuals typically install those wireless access points where convenient (e.g., where Internet connectivity enters a home, in a designated closet in an office, hidden away in ceiling tiles near a server rack) without necessarily optimizing the location and configuration of that wireless access point for public use. For example, the wireless access point might be located in an area where the signals are blocked by nearby objects, the antennae of the wireless access point might be arranged in a way that undesirably biases transmissions into one direction, the channel selection(s) of the wireless access point might be sub-optimal given other wireless networks in the area, the wireless access point might be wasting power by trying to transmit further distances than is necessary to serve the public in view of other wireless access points available to the public, or the like. That said, wireless access points and the user equipment they provide wireless networks to can be extremely rudimentary: standard wireless access points are not capable of moving on their own, wireless access points often run vendor-specific software that can be extremely limited in terms of its ability to transmit messages and configure parameters, and (for the most part) it is rarely guaranteed that user equipment in a particular region can be identified, much less instructed to connect to specific wireless networks.

As will be discussed in greater detail below, there may be a variety of ways in which the aspects described herein may be implemented. As one example, operating parameter changes for a particular wireless access point might be modified (e.g., to improve performance of the wireless access point) based on string(s) provided by that wireless access point. For instance, a string transmitted by a first wireless access point may suggest that the first wireless access point is experiencing significant packet loss or similar negative performance characteristics and, in turn, a channel and/or protocol of a wireless network provided by the wireless access point might be modified to improve such performance. This can, in general, significantly improve the performance of a wireless network, even in circumstances where the wireless access point is relatively rudimentary (e.g., where the wireless access point does not itself try to improve certain operating parameters). As another example, various wireless access points might report strings indicating their respective performance, and such information might be used to apportion different wireless operating parameters (e.g., different channels for wireless network(s) provided by each wireless access point, different geographic regions to be served by the wireless network(s) provided by each wireless access point, different signal strengths for the wireless network(s)). Among other improvements, this may enable the wireless access points to efficiently serve one or more geographic regions without conflict and in a manner that maximizes user experience (e.g., network speed, reliability). As yet another example, aspects described herein may comprise intelligently prompting a user to move a wireless access point (e.g., one under their control, such as in their home or office) to a new geographic location based on string(s) reflective of performance of that wireless access point. This might be implemented via a user interface displayed on a user device of the user (e.g., their smartphone or laptop), with the user interface providing detail such as a map of a geographic region, predicted performance improvements based on a recommended relocation of the wireless access point, and the like. One of the many advantages of this approach is that it may encourage users to move wireless access points under their control to a better location that can better serve other users, thereby improving the overall experience of users with wireless networks provided by those wireless access points.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

### Computing Architecture

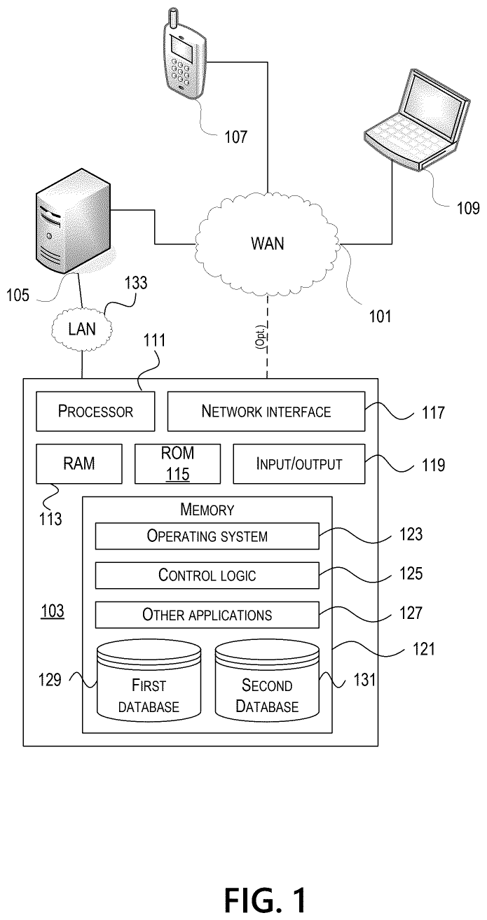

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as JavaScript and/or Python and/or markup language such as HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

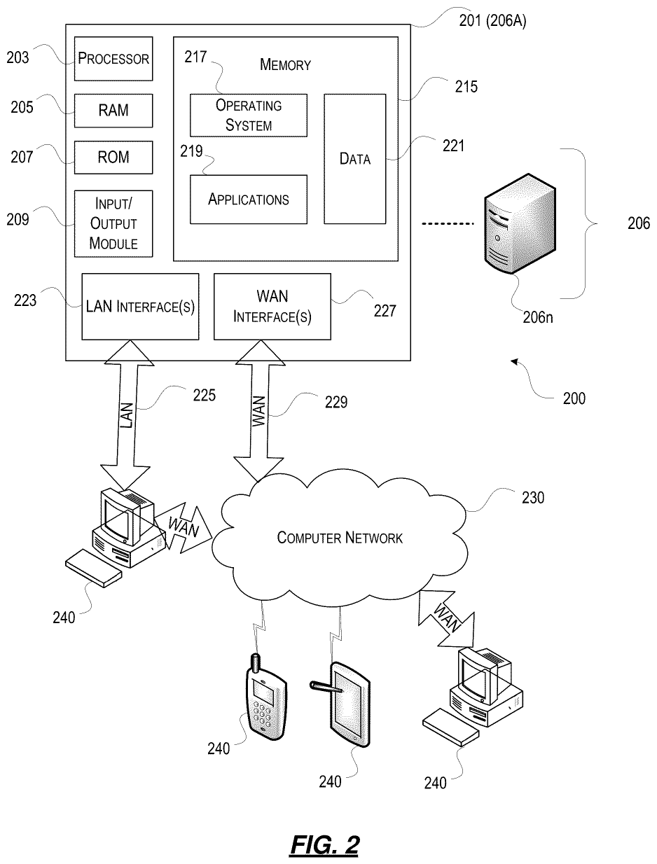

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server system. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

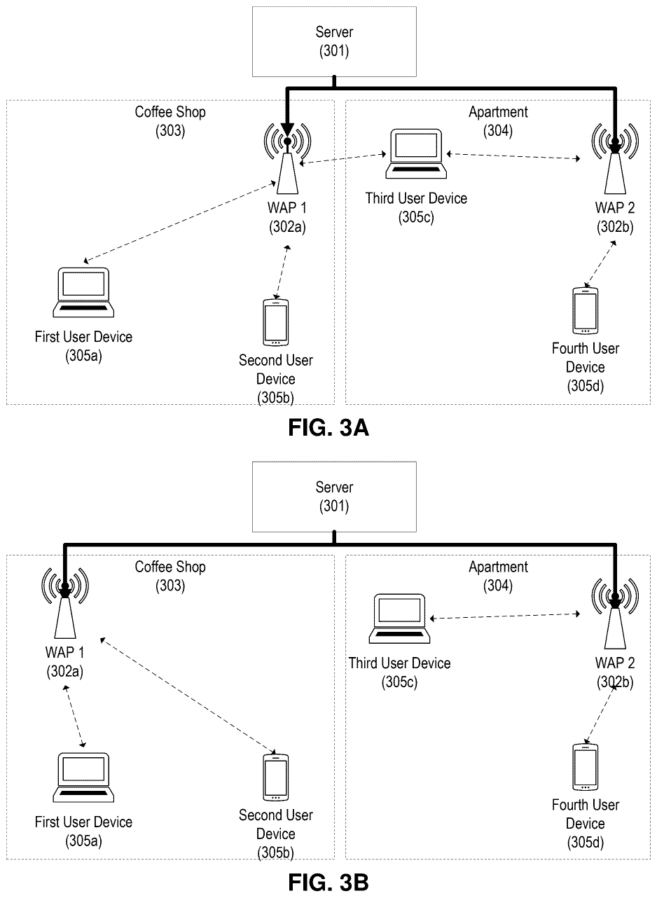

FIG. 3A depicts an illustrative system involving a server 301, a first wireless access point 302a and a second wireless access point 302b, and user devices including a first user device 305a, a second user device 305b, a third user device 305c, and a fourth user device 305d. Except for the server 301 (which might be located in a variety of different locations), the devices are, for the purposes of discussion, depicted in one of two physical locations: a coffee shop 303, or an apartment 304. Specifically, the first wireless access point 302a, the first user device 305a, and the second user device 305b are depicted in the coffee shop 303, whereas the third user device 305c, the fourth user device 305d, and the second wireless access point 302b are depicted in the apartment 304. These devices, including their relationship(s) and location(s), are depicted for the purposes of illustration: for example, a far larger quantity of user devices may exist, the distance between any device and/or physical location may differ, and/or a far larger variety of physical locations may exist. Moreover, any of the devices depicted in FIG. 3A may comprise any of the devices discussed with respect to FIG. 1 or FIG. 2, including but not limited to any of the components 103, 105, 107, 109, any of the client machine(s) 240, any of the servers 206a-206n, or the like. For instance, while the first user device 305a is depicted as a laptop, the first user device 305a may comprise a server, desktop computer, smartphone, Internet of Things (IoT) device, Internet-connected rideshare vehicle (such as an Internet-connected scooter), or the like.

The server 301 may be configured to manage the performance of one or more wireless access points, such as by dynamically improving wireless access point performance, dynamically assigning regions (e.g., physical locations) to wireless access points, improving locations of movable wireless access points, or the like. The server 301 may be configured to receive, from various wireless access points (such as the first wireless access point 302a and the second wireless access point 302b), information about the performance of those wireless access points when providing one or more wireless networks in various geographic regions. That information may be received as part of one or more strings, such as alphanumeric strings concatenating information corresponding to a plurality of different performance metrics. In such an example, the server 301 may be configured to identify individual metrics from strings by dividing the strings according to a template and/or predetermined standard and thereby process the metrics individually. Based on the performance of one or more wireless access points (e.g., based on comparing one or more performance metrics to a threshold), the server 301 may be configured to take one or more remedial actions. For example, the server 301 may be configured to modify operating parameters of one or more wireless access points in a manner predicted to improve performance (e.g., improve bandwidth, lower latency, avoid conflicts on a particular wireless channel). As another example, the server 301 may be configured to cause one or more wireless access points to connect (or refuse to connect) with user devices under certain circumstances, thereby indirectly controlling which user devices are connected to which wireless access points (e.g., for load balancing, to gently route user devices towards better-performing wireless access points given their particular location/circumstances). As yet another example, the server 301 may transmit, to a user device associated with an owner and/or manager of a particular wireless access point, a recommendation to move the particular wireless access point from one physical location to another.

Wireless access points, such as the first wireless access point 302a and the second wireless access point 302b, may be configured to provide one or more wireless networks to various devices, such as user devices. The wireless networks might comprise WiFi networks such as Wireless Local Area Networks (WLANs) and wireless personal area networks, Bluetooth networks, cellular and/or cell phone networks, near-field communication networks, or the like. These wireless networks may be provided via one or more radio frequency bands, which may be dictated by various protocol standards. For example, WLAN channels may include 860/900 MHz (such as for the Institute of Electrical and Electronics Engineers (IEEE) 802.11ah protocol), 2.4 GHz (such as for the IEEE 802.11b/g/n/ax/be protocol), 3.65 GHz (such as for the IEEE 802.11y), 4.9-5.0 GHz (such as for the IEEE 802.11j protocol), 5 GHz (such as for the IEEE 802.11a/h/n/ac/ax/be protocol), or the like. Wireless access points may provide any quantity of different wireless networks, including wireless networks in accordance with different protocols, different radio frequencies, or the like.

Wireless access points may be configurable using operating parameters, which may be any settings (e.g., options, ranges, limitations) used to control how one or more wireless networks are provided by a wireless access point. For example, operating parameters may specify which frequency bands to use, which channels of a frequency band to use, security settings for a wireless network (e.g., a particular security protocol, a particular password), speed settings (e.g., a maximum bandwidth per user), a Service Set Identifier (SSID) setting for the wireless network, an encryption setting for a wireless network, a Media Access Control (MAC) address of a wireless access point, a strength of transmissions by the wireless access point, a modulation technique of the wireless network, one or more Internet Protocol (IP) addresses used in the wireless network, or the like. Different wireless networks may be controllable via different operating parameters. For example, Bluetooth networks might be configurable to be between a “low energy” and classic/standard mode, whereas IEE 802.11 wireless networks might also be configurable to be low energy, albeit via control of transmission strength.

The performance of one or more wireless networks provided by a wireless access point may be measured using one or more metrics. Examples of metrics include received signal strength, bandwidth and/or throughput, latency (e.g., packet latency), jitter, packet loss, signal-to-noise ratio (SNR), channel utilization, network availability, error rate, network uptime, round-trip time, packet duplication, network congestion, retransmission rate, or the like. Different wireless networks might be measurable by different metrics: for example, one wireless network protocol might be capable of measurement of connection, advertisement, and/or scan intervals/windows, whereas others might be capable of measuring packet round-trip time.

User devices, such as the first user device 305a, the second user device 305b, the third user device 305c, and the fourth user device 305d, may comprise one or more computing devices that are capable of connecting to one or more wireless networks. For example, user devices may comprise smartphones, IoT devices, laptops, wirelessly-connected appliances, wirelessly-connected vehicles such as scooters or cars, and the like. Some user devices (such as smartphones) might frequently move around to different physical locations (e.g., when carried in a user's pocket), whereas others (such as a wirelessly-connected appliance or desktop computer) might remain substantially still when in use. These devices may be capable of connecting to wireless networks on a variety of channels (e.g., channels of a wireless spectrum band defined for a particular protocol or wireless communication method) to communicate with other devices, such as over the Internet.

FIG. 3B, in conjunction with FIG. 3A, depicts how movement of a physical location of a wireless access point might change how various wireless access points provide wireless networks to various user devices. In FIG. 3A, the first wireless access point 302a is shown providing a wireless network to the first user device 305a, the second user device 305b, and the third user device 305c, whereas the second wireless access point 302b is shown as providing a wireless network to only the fourth user device 305d. This is slightly suboptimal: this means that the first wireless access point 302a might be overloaded, the second wireless access point 302b might be underused, and the third user device 305 might receive suboptimal network performance because the wireless network provided by the first wireless access point 302a is forced to travel through wall(s) of the coffee shop 303 and the apartment 304. Relative to FIG. 3A, FIG. 3B shows that the first wireless access point 302a has been moved to a different location in the coffee shop 303. This means that the third user device 305c is now receiving a wireless network from the second wireless access point 302b, rather than the first wireless access point 302a. In this circumstance, this approach may be ideal: it might load balance between the two wireless access points in a more desirable way, might result in better wireless network performance for the third user device 305c, and the like. As will be detailed further below, this moving process might be effectuated by prompting an owner of the first wireless access point 302a (such as a manager of the coffee shop 303) to move the first wireless access point 302a.

### Dynamic Improvement of Wireless Access Point Performance

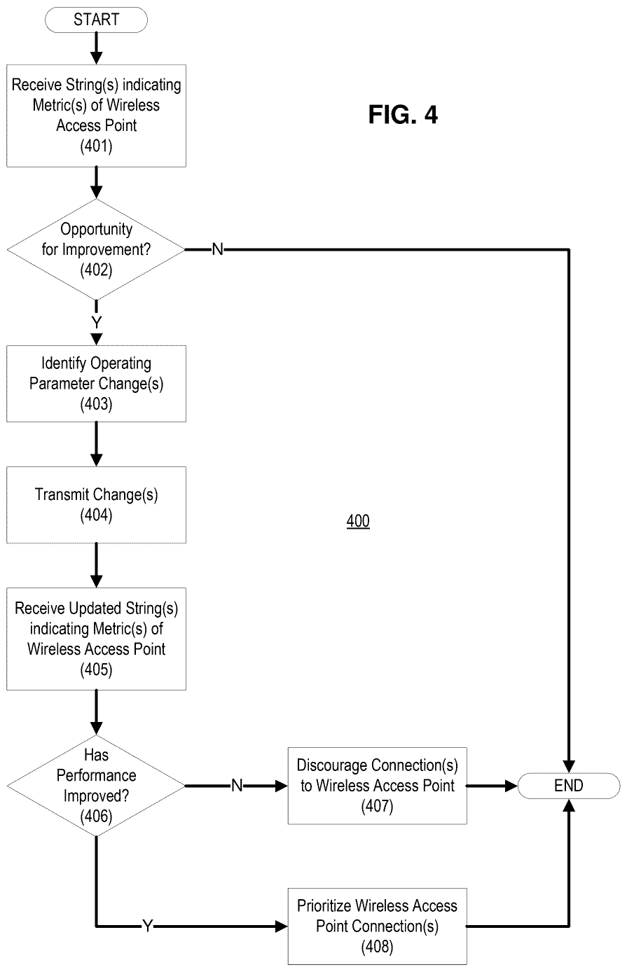

FIG. 4 depicts a method 400 comprising steps for dynamically improving wireless access point performance which may be performed by a computing device, such the server 301 and/or any of the other devices depicted in FIG. 1, FIG. 2, and/or FIG. 3. The steps shown in FIG. 4 are illustrative, and may be re-arranged, omitted, and/or modified as desired. A computing device may comprise one or more processors and memory storing instructions that, when executed by the one or more processors, cause the performance of one or more of the steps depicted in FIG. 4. One or more non-transitory computer-readable media may store instructions that, when executed, cause the performance of one or more of the steps depicted in FIG. 4.

In step 401, a computing device may receive one or more strings indicating one or more metrics of a wireless access point. These strings may be received from various wireless access points over one or more time periods. For example, this step may comprise receiving, by a server and from a first wireless access point, a first string indicating a first set of metrics corresponding to performance, by the first wireless access point, when providing a first wireless network in a geographic region. The one or more strings may indicate metrics for one or more time periods in a variety of ways. For example, one or more of the strings may comprise a plurality of alphanumeric values concatenating at least two different measurements, such as of at least one Received Signal Strength Indicator (RSSI), downstream bit rate, upstream bit rate, channel utilization, frame loss, and/or latency. The wireless access points may be configured to generate and transmit these strings on a periodic basis, such as every ten minutes, every hour, or the like.

One of the many advantages of the process described herein is that the string may be included in a preexisting messaging/protocol process. For instance, the first string may be received via a Remote Authentication Dial-In User Service (RADIUS) networking protocol. Particularly, in such an example, the metrics may be combined into an alphanumeric string into the “connect-info” (Attribute 77) field of a RADIUS connection. That alphanumeric format might be composed in a format like “CONNECT %.2f Mbps 802.11ac Channel:%d Band:%s RSSI:%d Noise:%d Chan Util:%d TxBitRate:%. If Mbps RxBitRate:%. If Mbps FrameLoss:%.0f FrameRetry:%.0f,” where “CONNECT” refers to connection speed in Mbps, “Channel” refers to channel number, “Band” refers to frequency band, RSSI comprises a measurement from the wireless access point at a particular time, “Noise” refers to noise data collected via survey, “ChanUtil” refers to channel utilization (which might be a percentage of time the channel was busy), “TxBitRate” refers to transmission bitrate, “RxBitRate” refers to receive bitrate, and “FrameLoss” refers to a percentage of transmitted packets that failed, “FrameRetry” refers to a percentage of transmitted packets that were retried. This information may be collected via wireless access point station metrics (providing detailed information about connections), survey metrics (providing channel-wide information, such as noise and channel utilization), and interface metrics (e.g., supported frequencies). For instance, to prepare a string for inclusion as part of the “connect-info” field, a wireless access point might collect the appropriate station, survey, and/or interface metrics, generate a string in accordance with the template defined above, then add that string to the “connect-info” field at the next available opportunity in compliance with the RADIUS protocol.

Upon receipt of a string, the computing device may pre-process and/or otherwise modify the string to identify one or more metrics indicated in a string. For example, the computing device may identify a first set of metrics by splitting the first string into a plurality of different portions and correlating each of the plurality of different portions of the string to a different metric of the first set of metrics. This splitting process may also be based on a template, such as the template described above with respect to the RADIUS protocol.

In step 402, the computing device may identify whether there are any opportunities to improve the wireless access point. This step may comprise identifying one or more ways that aspects of a wireless access point (e.g., operating parameters, the physical location of the wireless access point) can be modified to improve user experience (e.g., increase bandwidth, lower packet loss and/or retransmission, lower channel utilization). This process may comprise comparing the metrics to some threshold: for example, this step may comprise comparing the first set of metrics to a grading standard. That grading standard may comprise, for example, one or more rules for offloading, based on metric measurements, connected user devices. If there are opportunities for improvement, the method 400 may proceed to step 403. Otherwise, the method 400 may end.

Use of a grading standard may comprise grading and/or otherwise scoring one or more wireless access points based on a grading scale, such as a scale from “A” to “D” and/or a scale from zero to one). In such a circumstance, multiple different metrics may be considered and used to affect a total score, thereby enabling a single score (e.g., the “A” or “D,” a numeric scale from zero to one) to represent an overall performance as identified based on a plurality of different metrics that might indicate such performance. To generate such a grading, various normalization steps and/or weighting steps may be used. For instance, values might be normalized on an appropriate scale (e.g., from zero to one or a similar scale), then weighted differently such that each normalized metric comprises a different portion of the total grading. As a particular example, the below table reflects one illustrative approach to grading, considering the normalization of different ranges of measurements, the percentiles used for grading, and whether lower values or higher values are better:

TABLE 1

| | | Normalization | Higher = |
|---|---|---|---|
| Metric | Quantile | Range | Better? |
| RSSI | 10^{th} Percentile | −60 to −85 | Yes |
| Noise | Median | −95 to −80 | No |
| Transmission Rate | 10^{th} Percentile | 1145 to 6 | Yes |
| Reception Rate | 10^{th} Percentile | 1145 to 6 | Yes |
| Backhaul Download | 10^{th} Percentile | 200 to 5 | Yes |
| Throughput | | | |
| Channel Utilization | 90^{th} Percentile | 80 to 0 | No |
| Loss | 90^{th} Percentile | 10 to 0 | No |
| Retry | 90^{th} Percentile | 25 to 0 | No |
| Station Count | 90^{th} Percentile | 60 to 5 | No |

The weighting, normalization, and/or quantity of metrics may be modified over time to improve performance. For example, over time, the “Retry” metric above may be identified as of low probative value when improving network performance. That metric may then be ignored in future calculations (that is, the weight assigned to that metric might be instead assigned to another metric, like noise).

Grading and/or scoring may be performed on a per-connection and/or per-wireless access point basis. For instance, some grades may be per wireless access point, such that a first wireless access point might be given a grade of “A,” whereas a second wireless access point may be given a grade of “C.” With that said, additionally and/or alternatively, individual connections (e.g., between a wireless access point and one or more user devices) may be graded/scored. This may account for the idea that a user device might have a better score when connecting to one wireless access point than another, even if the wireless access points have the same total grade (e.g., both have a “B” grade). After all, the location of a user device may play a major part in the quality of the connection.

In step 403, the computing device may identify one or more operating parameter changes. This step may comprise identifying one or more operating parameters of a wireless access point that, if changed, are predicted to result in improved performance of the wireless access point (e.g., for a particular user device, for a plurality of user devices, as estimated in simulation). For example, this step may comprise identifying one or more operating parameter changes predicted to improve a performance (e.g., one or more metrics indicating performance) of the wireless access point. Such a prediction may be made using simulation, such as by simulating possible operating parameter changes using a simulation model based on information known about a geographic location, a use pattern of the wireless access point in question, or the like.

The operating parameter changes and/or the identification of opportunities to improve the wireless access point may be based on strings, metrics, and/or other information about wireless access points other than the wireless access point to be changed. For instance, either or both step 402 and/or step 403 may entail receiving, by the server and from one or more second wireless access points providing the one or more second wireless networks in the geographic region, a plurality of second strings indicating a plurality of sets of second metrics corresponding to performance, by the one or more second wireless access points, and then using those received strings as part of identifying opportunities to improve the wireless access point and/or identifying one or more operating parameter changes. In this way, for example, more information about the environment of a wireless access point (e.g., other wireless access points that might be trying to use a similar frequency and/or bandwidth) might be used to better decide how to modify the operating parameters of the wireless access point in question.

The operating parameter changes and/or the identification of opportunities to improve the wireless access point may be based on trends observed in the performance of a wireless access point. In this manner, performance of a particular wireless access point over time (e.g., during busy hours, such as a lunch rush in a restaurant) may be considered and used to tune operating parameters. For instance, either or both step 402 and/or step 403 may entail receiving, by the server and from the first wireless access point, one or more second strings indicating a plurality of different sets of metrics corresponding to performance, by the first wireless access point, when providing the first wireless network in the geographic region at different times and calculating, based on the first set of metrics and the plurality of different sets of metrics, a performance trend of the first wireless access point. In turn, the operating parameter changes may comprise configuring a wireless access point to modify its operating parameters based on a schedule (e.g., using one channel during busy hours but switching the channel during quiet hours).

In step 404, the computing device may transmit the one or more operating parameter changes. This may comprise generating instructions configured to cause a particular wireless access point to modify its operating parameters and then transmitting those instructions to the wireless access point in question. For example, this step may comprise transmitting, to the first wireless access point, instructions configured to cause the first wireless access point to implement the one or more operating parameter changes. These instructions may be based on a manufacturer and/or model of wireless access point, such that the format of instructions for one brand of wireless access point may differ from the format of instructions for another brand of wireless access point.

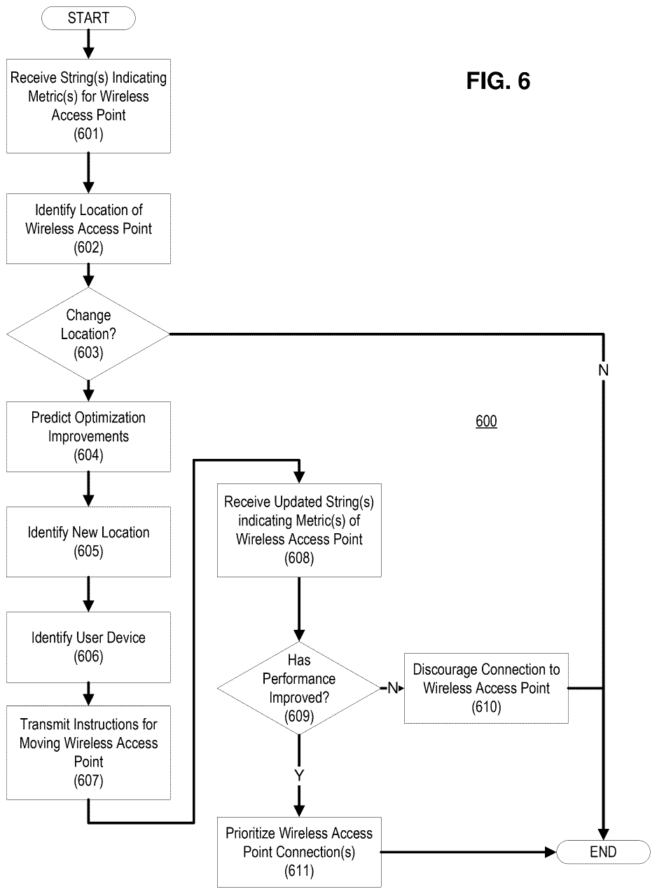

In addition to the modification of specific operating parameters, and as will be described in greater detail below with respect to FIG. 6, performance of a wireless access point may be improved by prompting a user (e.g., an owner) of the wireless access point to move a physical location of the wireless access point. For example, this may comprise transmitting, to a second user device associated with an owner of the first wireless access point, instructions to move a physical location of the first wireless access point, wherein the causing the first user device to prioritize the wireless connectivity via the first wireless network is based on determining that the physical location of the first wireless access point has changed. This process might, in some circumstances, involve recommendations to move the wireless access point to avoid obstacles in the way of a signal from the wireless access point. For example, this process may entail determining the instructions to move the physical location of the first wireless access point by identifying a first physical location of the first wireless access point, predicting, based on the first physical location of the first wireless access point, one or more impediments to signals transmitted by the first wireless access point, and then identifying, based on the predicted one or more impediments to signals transmitted by the first wireless access point, a second physical location, wherein the instructions to move the physical location of the first wireless access point indicate the second physical location.

In step 405, the computing device may receive one or more updated strings indicating one or more updated metrics of the wireless access point. In this manner, the computing device may receive metrics that might indicate whether the operating parameter changes were adopted and successful. For example, this step may comprise receiving, by the server and from the first wireless access point, a second string indicating an updated plurality of metrics corresponding to performance, by the first wireless access point, when providing the first wireless network in the geographic region. Such strings and/or metrics may be substantially similar to those received in step 401.

In step 406, the computing device may determine whether performance has improved. This might comprise comparing the metrics received in step 405 to the metrics received in step 401 and/or comparing the metrics to a baseline standard, such as a minimum service requirement. If performance has improved, the method 400 may proceed to step 408. Otherwise, if the performance has not improved, the method may proceed to step 407.

In step 407, based on performance not improving, the computing device may discourage connection(s) to the wireless access point. For example, this step may comprise instructing the wireless access point to deny connections from certain user devices and/or to disable certain functions. This process might be performed where, for instance, the wireless access point is overloaded (e.g., such that denying a fraction of connection requests might itself free up the wireless access point and thereby improve performance) and/or where another wireless access point (e.g., another wireless access point in the same building) can take over responsibility for the connections and provide better user experiences. In this manner, an under-performing wireless access point might be gently withdrawn from use under some circumstances, which might itself result in a net improvement to wireless network performance.

In step 408, based on performance improving, the computing device may prioritize wireless access point connections. For example, this step may comprise causing, based on the updated plurality of metrics, a first user device to prioritize wireless connectivity via the first wireless network over one or more second wireless networks in the geographic region. In some circumstances, this may comprise instructing a user device to favor one wireless access point over another based on the SSID of a wireless network provided by the wireless access point, the MAC address of the wireless access point, or the like.

One (way that a particular wireless access point might be prioritized, such as for a particular user device, is by causing other wireless access points to discourage other wireless access points from connecting to the user device. This may comprise ensuring that other wireless access points do not compete with the improved wireless access point to serve certain user devices and/or connections. For example, this may comprise transmitting, to one or more second wireless access points providing the one or more second wireless networks in the geographic region, second instructions configured to cause the one or more second wireless access points to deny connection requests from the first user device. One of the many advantages of this approach is that it need not involve direct messaging to user devices. In other words, this approach allows the computing device to encourage user devices to connect to specific wireless access points, even if those user devices might not be configured to be directly instructed to do so.

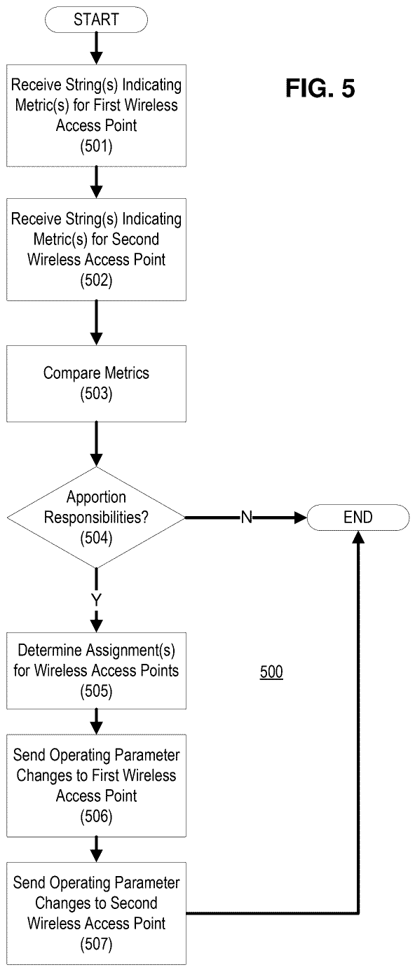

FIG. 5 depicts a method 500 comprising steps for dynamically assigning regions to wireless access points which may be performed by a computing device, such the server 301 and/or any of the other devices depicted in FIG. 1, FIG. 2, and/or FIG. 3. The steps shown in FIG. 5 are illustrative, and may be re-arranged, omitted, and/or modified as desired. A computing device may comprise one or more processors and memory storing instructions that, when executed by the one or more processors, cause the performance of one or more of the steps depicted in FIG. 5. One or more non-transitory computer-readable media may store instructions that, when executed, cause the performance of one or more of the steps depicted in FIG. 5.

In step 501, a computing device may receive one or more strings indicating one or more metrics for a first wireless access point. This step may be the same or similar as step 401 of FIG. 4. For example, this step may comprise receiving, by a server and from a first wireless access point, a first string indicating a first set of metrics corresponding to performance, by the first wireless access point, when providing a first wireless network in a geographic region.

In step 502, the computing device may receive one or more strings indicating one or more metrics for a second wireless access point. This step may also be the same or similar as step 401 of FIG. 4. For example, this step may comprise receiving, by the server and from a second wireless access point providing a second wireless network in the geographic region, a second string indicating a second set of second metrics corresponding to performance, by the second wireless access point, when providing the second wireless network in the geographic region.

In step 503, the computing device may compare metrics. This may comprise comparing metrics for the first wireless access point to the second wireless access point. For example, this step may comprise comparing, based on the first set of metrics and the second set of second metrics, performance of the first wireless access point and the second wireless access point. The comparison may be metric-by-metric, such as comparing a loss rate of the first wireless access point to a loss rate of the second wireless access point.

In step 504, the computing device may determine, based on the comparing, whether it should apportion responsibilities amongst the wireless access points. For example, this step may comprise determining whether modification of one or more aspects of the wireless access points (e.g., the operating parameters of either or both wireless access point, the location of either or both wireless access point) in a manner that divides responsibilities between the access points (e.g., apportions each wireless access point to a different geographic region, channel, type of connection, type of wireless network) is predicted to improve a performance of either or both wireless access points (and/or the wireless networks/connections provided by such wireless access points). If it is decided to apportion responsibilities, the method 500 may proceed to step 505. Otherwise, the method 500 may end.

In step 505, the computing device may determine one or more assignments for the wireless access points. An assignment may be for a specific physical region (e.g., each wireless access point is tasked with servicing a different portion of an office, a store, an apartment), channel assignments (e.g., one provides networks via channel 3 and the other provides networks via channel 6), wireless protocol assignments (e.g., one handles 802.11a, another handles 802.11g), or the like. One of the many reasons for this process is to avoid conflict between wireless access points: for example, by using different channels and servicing different physical regions, wireless access point transmissions are less likely to conflict, potentially resulting in less packet loss and packet retransmission. Such an approach may be particularly valuable where a large quantity of wireless access points are in the same building (e.g., an office building or apartment building), given that such conflicts can significantly reduce the overall reliability and speed of wireless connections.

As already briefly introduced above, determining the one or more assignments for various wireless access points may comprise apportioning different portions of a geographic region to different wireless access points. This may comprise using the metrics from different wireless devices to identify portions of a geographic region that the wireless access points might best serve. For example, this step may comprise identifying the first portion of the geographic region based on the first set of metrics and/or identifying the second portion of the geographic region based on the second set of metrics. As part of this process, information about known locations of wireless access points might be used. For instance, if two wireless access points are known to be on opposite sides of the room and one wireless access point indicates significantly higher load than the other, than such a result might counsel for lowering the transmission power of one and increasing the transmission power of another to help offload some of the load.

Determining the one or more assignments may additionally and/or alternatively comprise estimating user experiences based on their location. A predictive model may be used to predict the effect of user location and connections between that user and one or more wireless access points, such that the predictions may be used to identify which wireless access points should be responsible for portions of a geographic region. For example, this step may comprise estimating a first user experience of connected user devices when communicating via the first wireless network from a plurality of different locations in the geographic region and/or estimating a second user experience of the connected user devices when communicating via the second wireless network from a plurality of different locations in the geographic region.

In step 506, the computing device may send one or more operating parameter changes to the first wireless access point. These operating parameter changes may be based on the assignments determined in step 505. For example, this step may comprise causing, based on the comparing, the first wireless access point to provide wireless connectivity via the first wireless network within a first portion of the geographic region and/or reject wireless connectivity via the first wireless network within a second portion of the geographic region. To perform this process, one or more instructions may be transmitted: for instance, sending the one or more operating parameter changes may comprise transmitting, to the first wireless access point, instructions configured to cause the first wireless access point to implement the one or more operating parameter changes.

In step 507, the computing device may send one or more operating parameter changes to the second wireless access point. This step may be the same or similar as step 506, albeit with respect to the second wireless access point. For example, this step may comprise causing, based on the comparing, the second wireless access point to provide wireless connectivity via the second wireless network within the second portion of the geographic region and/or reject wireless connectivity via the second wireless network within the first portion of the geographic region.

In either or both step 506 and/or step 507, a user might be prompted to move a location of one or more wireless access points. This prompt may be particularly useful where, for example, it is decided to assign one wireless access point one part of a geographic region and another wireless access point a different part of the geographic region, such that moving one or more of the wireless access points ensures that both wireless access points can better serve their respective portions. For example, this may comprise transmitting, to a second user device associated with an owner of the first wireless access point, instructions to move a physical location of the first wireless access point to a location associated with the first portion of the geographic region.

FIG. 6 depicts a method 600 comprising steps for improving locations of movable wireless access points which may be performed by a computing device, such the server 301 and/or any of the other devices depicted in FIG. 1, FIG. 2, and/or FIG. 3. The steps shown in FIG. 6 are illustrative, and may be re-arranged, omitted, and/or modified as desired. A computing device may comprise one or more processors and memory storing instructions that, when executed by the one or more processors, cause the performance of one or more of the steps depicted in FIG. 6. One or more non-transitory computer-readable media may store instructions that, when executed, cause the performance of one or more of the steps depicted in FIG. 6.

In step 601, a computing device may receive one or more strings indicating one or more metrics for a wireless access point. This step may be the same or similar as step 401 of FIG. 4. For example, this step may comprise receiving, by a server and from a first wireless access point, a first string indicating a first set of metrics corresponding to performance, by the first wireless access point, when providing a first wireless network in a geographic region.

In step 602, the computing device may identify a location of the wireless access point. A location of a wireless access point may be determined through user input, such as via a user specifying (e.g., on a map, in a drop-down menu of possible options) a location of the wireless access point. Additionally and/or alternatively, the location of a wireless access point may be determined through Global Positioning System (GPS) coordinates. Such coordinates may be acquired directly from the wireless access point, such as via a GPS module of the wireless access point. Additionally and/or alternatively, the coordinates may be inferred via one or more user devices: for example, user devices such as smartphones may be configured to report their GPS coordinates to the computing device, and those coordinates (along with, for example, received signal strength measurements from the user devices) may be used to infer a geographic location of the wireless access point.

In step 603, the computing device may determine whether the location of the wireless access point should be changed. This determination may be made based on metrics: for example, a high rate of packet loss, a high packet retransmission rate, and/or other metrics may suggest that the location of the wireless access point may be in some manner sub-optimal. In general, the standard for moving a wireless access point may be somewhat higher than changing operating parameters, giving that changing operating parameters can be performed relatively quickly (and easily reversed if needed), whereas locational changes might involve human labor and time expenditure. If it is decided to change the location of the wireless access point, the method 600 may proceed to step 604. Otherwise, the method 600 may end.

In step 604, the computing device may predict one or more optimization improvements for various locations. This may comprise evaluating various options for relocation of the wireless access point (e.g., various corners of a room, various rooms of an office, various locations in a stadium) and predicting, based on those options, corresponding metrics for wireless performance if the wireless access point were relocated there. This may additionally and/or alternatively include predicting the existence of objects (e.g., large metal objects, walls, furniture) that might impede signals. For example, this step may comprise predicting, based on the first physical location of the first wireless access point and based on the first set of metrics, one or more impediments to signals transmitted by the first wireless access point. To identify such impediments, objects might be predicted: for example, this process might involve predicting a presence of one or more objects near the first wireless access point. The prediction of an object might be based on signal strengths, such as based on signal strengths from user devices at various points in the geographic region (e.g., and the identification that, when user devices are in a certain area, the quality of their connection drops significantly, suggesting some physical object between the user devices and the wireless access point).

In step 605, the computing device may identify a new location for the wireless access point. This may comprise identifying, from a plurality of possible new locations, an optimized location based on predicted metrics corresponding to that location and/or based on a prediction of an absence of one or more objects impeding signals in that location. For example, this step may comprise identifying, based on the predicted one or more impediments to signals transmitted by the first wireless access point, a second physical location.

In step 606, the computing device may identify a user device associated with the wireless access point. This may comprise identifying a user device of an owner and/or manager of the wireless access point and/or a user device associated with a user with permission to physically move the wireless access point. For example, this step may comprise identifying a first user device associated with an owner of the first wireless access point. The user device need not be connected and/or nearby the wireless access point. Moreover, this step need not comprise identifying the user device in any particular way: generally, this step may be satisfied by identifying an e-mail address, phone number, instant messaging username, IP address, and/or other way to transmit information to the user device.

In step 607, the computing device may transmit instructions for moving the wireless access point. For example, this step may comprise transmitting, to a first user device associated with an owner of the first wireless access point, instructions to move a physical location of the first wireless access point from the first physical location to the second physical location. As a particular example, this step may comprise transmitting an alphanumeric string (e.g., “please move your wireless access point to the other side of the room” or the like. The instructions may additionally and/or alternatively be presented, to a user, as part of a user interface. For instance, step 607 may comprise causing the first user device to display a user interface indicating a score of the first wireless access point relative to one or more other wireless access points and/or a map representing the first physical location and the second physical location. Such a map may indicate, for example, the existing location of the wireless access point on the map, a proposed new location of the wireless access point on the map, and text describing predicted improvements (e.g., in terms of packet loss, transmission speed) associated with the movement of the wireless access point.

After the wireless access point has moved, additional operating parameter changes might be implemented. This process may be the same or similar as step 403 and/or step 404 of FIG. 4. For instance, this may include transmitting, to the first wireless access point and based on the determination that the first wireless access point has been moved from the first physical location to the second physical location, instructions configured to cause the first wireless access point to implement one or more operating parameter changes.

In step 608, a computing device may receive one or more updated strings indicating one or more updated metrics for the wireless access point. This step may be the same or similar as step 405 of FIG. 4. For example, this step may comprise receiving, by the server, from the first wireless access point, and based on a determination that the first wireless access point has been moved from the first physical location to the second physical location, a second string indicating an updated plurality of metrics corresponding to performance, by the first wireless access point, when providing the first wireless network in the geographic region.

In step 609, a computing device may determine whether performance has improved. This step may be the same or similar as step 406 of FIG. 4. If the performance has improved, the method 600 may proceed to step 611. Otherwise, if performance has not improved, the method 600 may proceed to step 610.

In step 610, based on performance not improving, the computing device may discourage connections to the wireless access point. This step may be the same or similar as step 407 of FIG. 4. For example, this step may comprise instructing the wireless access point to deny certain connection requests from certain user devices.

In step 611, based on performance improving, the computing device may prioritize connections to the wireless access point. This may be the same or similar as step 408 of FIG. 4. For example, this step may comprise causing, based on the updated plurality of metrics, a second user device to prioritize wireless connectivity via the first wireless network over one or more second wireless networks in the geographic region. This step may also comprise discouraging other wireless access points from providing services to certain user devices: for example, it may comprise transmitting, to one or more second wireless access points providing the one or more second wireless networks in the geographic region, second instructions configured to cause the one or more second wireless access points to deny connection requests from the second user device.

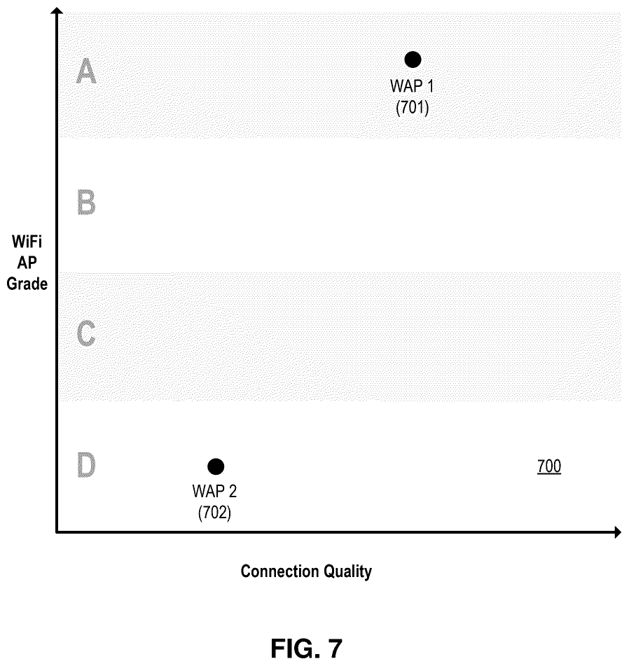

FIG. 7 depicts one representation of how wireless access points may be graded using a chart 700 that compares wireless access point grades to connection quality. In this example, a first wireless access point 701 is shown having a grade of “A” and a moderate connection quality, whereas the second wireless access point 702 is shown as having a grade of “D” and a low connection quality. Note that the grade is not always indicative of connection quality: after all, there may be circumstances (e.g., peak demand periods, crowded stadiums) where connection quality is poor and yet a wireless access point may be performing as well as it can in the circumstances. In this example, points closer to the origin (e.g., the second wireless access point 702) might correspond to wireless access points that might be offloaded more readily than points further away from the origin. For example, in the example depicted in FIG. 7, there may be more need to move a location and/or modify the operating parameters of the second wireless access point 702. Additionally and/or alternatively, user devices may be encouraged to connect to the first wireless access point 701 rather than the second wireless access point 702 until the performance concerns of the second wireless access point 702 are addressed.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method for dynamically improving wireless access point performance, the method comprising:
receiving, by a server and from a first wireless access point, a first string indicating a first set of metrics corresponding to performance, by the first wireless access point, when providing a first wireless network in a geographic region;
identifying, based on comparing the first set of metrics to a grading standard, one or more operating parameter changes for the first wireless access point;
transmitting, to the first wireless access point, instructions configured to cause the first wireless access point to implement the one or more operating parameter changes;
receiving, by the server and from the first wireless access point, a second string indicating an updated plurality of metrics corresponding to performance, by the first wireless access point, when providing the first wireless network in the geographic region; and
causing, based on the updated plurality of metrics, a first user device to prioritize wireless connectivity via the first wireless network over one or more second wireless networks in the geographic region.

2. The method of claim 1, wherein the causing the first user device to prioritize the wireless connectivity via the first wireless network comprises:
transmitting, to one or more second wireless access points providing the one or more second wireless networks in the geographic region, second instructions configured to cause the one or more second wireless access points to deny connection requests from the first user device.

3. The method of claim 1, further comprising:
transmitting, to a second user device associated with an owner of the first wireless access point, instructions to move a physical location of the first wireless access point, wherein the causing the first user device to prioritize the wireless connectivity via the first wireless network is based on determining that the physical location of the first wireless access point has changed.

4. The method of claim 3, further comprising:
determining the instructions to move the physical location of the first wireless access point by:
identifying a first physical location of the first wireless access point;
predicting, based on the first physical location of the first wireless access point, one or more impediments to signals transmitted by the first wireless access point; and
identifying, based on the predicted one or more impediments to signals transmitted by the first wireless access point, a second physical location, wherein the instructions to move the physical location of the first wireless access point indicate the second physical location.

5. The method of claim 1, further comprising:
receiving, by the server and from one or more second wireless access points providing the one or more second wireless networks in the geographic region, a plurality of second strings indicating a plurality of sets of second metrics corresponding to performance, by the one or more second wireless access points, when providing one or more second wireless networks in the geographic region, wherein the identifying the one or more operating parameter changes for the first wireless access point is further based on the plurality of sets of second metrics.

6. The method of claim 1, further comprising:
receiving, by the server and from the first wireless access point, one or more second strings indicating a plurality of different sets of metrics corresponding to performance, by the first wireless access point, when providing the first wireless network in the geographic region at different times; and
calculating, based on the first set of metrics and the plurality of different sets of metrics, a performance trend of the first wireless access point, wherein the identifying the one or more operating parameter changes for the first wireless access point is further based on the performance trend.

7. The method of claim 1, further comprising:
identifying the first set of metrics by:
splitting the first string into a plurality of different portions; and
correlating each of the plurality of different portions of the string to a different metric of the first set of metrics.

8. The method of claim 1, wherein the first string comprises a plurality of alphanumeric values concatenating measurements of at least two of:
at least one Received Signal Strength Indicator (RSSI);
downstream bit rate;
upstream bit rate;
channel utilization;
frame loss; and
latency.

9. The method of claim 1, wherein the grading standard comprises one or more rules for offloading, based on metric measurements, connected user devices.

10. The method of claim 1, wherein the receiving the first string indicating the first set of metrics comprises receiving the first string via a Remote Authentication Dial-In User Service (RADIUS) networking protocol.

11. A method for dynamically assigning regions to wireless access points, the method comprising:
receiving, by a server and from a first wireless access point, a first string indicating a first set of metrics corresponding to performance, by the first wireless access point, when providing a first wireless network in a geographic region;
receiving, by the server and from a second wireless access point providing a second wireless network in the geographic region, a second string indicating a second set of second metrics corresponding to performance, by the second wireless access point, when providing the second wireless network in the geographic region;
comparing, based on the first set of metrics and the second set of second metrics, performance of the first wireless access point and the second wireless access point;
causing, based on the comparing, the first wireless access point to:
provide wireless connectivity via the first wireless network within a first portion of the geographic region, and
reject wireless connectivity via the first wireless network within a second portion of the geographic region; and
causing, based on the comparing, the second wireless access point to:
provide wireless connectivity via the second wireless network within the second portion of the geographic region, and
reject wireless connectivity via the second wireless network within the first portion of the geographic region.

12. The method of claim 11, further comprising:
identifying the first portion of the geographic region based on the first set of metrics; and
identifying the second portion of the geographic region based on the second set of metrics.

13. The method of claim 11, wherein the causing the first wireless access point to provide the wireless connectivity via the first wireless network within the first portion of the geographic region comprises:
transmitting, to the first wireless access point, instructions configured to cause the first wireless access point to implement the one or more operating parameter changes.

14. The method of claim 11, wherein the causing the first wireless access point to provide the wireless connectivity via the first wireless network within the first portion of the geographic region comprises:
transmitting, to a second user device associated with an owner of the first wireless access point, instructions to move a physical location of the first wireless access point to a location associated with the first portion of the geographic region.

15. The method of claim 11, wherein the comparing the performance of the first wireless access point and the second wireless access point comprises:
estimating a first user experience of connected user devices when communicating via the first wireless network from a plurality of different locations in the geographic region; and
estimating a second user experience of the connected user devices when communicating via the second wireless network from a plurality of different locations in the geographic region.

16. A method for improving locations of movable wireless access points, the method comprising:
receiving, by a server and from a first wireless access point, a first string indicating a first set of metrics corresponding to performance, by the first wireless access point, when providing a first wireless network in a geographic region;
identifying a first physical location of the first wireless access point;
predicting, based on the first physical location of the first wireless access point and based on the first set of metrics, one or more impediments to signals transmitted by the first wireless access point;
identifying, based on the predicted one or more impediments to signals transmitted by the first wireless access point, a second physical location;
transmitting, to a first user device associated with an owner of the first wireless access point, instructions to move a physical location of the first wireless access point from the first physical location to the second physical location;
receiving, by the server, from the first wireless access point, and based on a determination that the first wireless access point has been moved from the first physical location to the second physical location, a second string indicating an updated plurality of metrics corresponding to performance, by the first wireless access point, when providing the first wireless network in the geographic region; and
causing, based on the updated plurality of metrics, a second user device to prioritize wireless connectivity via the first wireless network over one or more second wireless networks in the geographic region.

17. The method of claim 16, further comprising:
transmitting, to the first wireless access point and based on the determination that the first wireless access point has been moved from the first physical location to the second physical location, instructions configured to cause the first wireless access point to implement one or more operating parameter changes.

18. The method of claim 16, wherein the transmitting the instructions to move the physical location of the first wireless access point from the first physical location to the second physical location comprises:
causing the first user device to display a user interface indicating:
a score of the first wireless access point relative to one or more other wireless access points; and
a map representing the first physical location and the second physical location.

19. The method of claim 16, wherein the causing the second user device to prioritize the wireless connectivity via the first wireless network comprises:
transmitting, to one or more second wireless access points providing the one or more second wireless networks in the geographic region, second instructions configured to cause the one or more second wireless access points to deny connection requests from the second user device.

20. The method of claim 16, wherein the predicting the one or more impediments to signals transmitted by the first wireless access point comprises:
predicting a presence of one or more objects near the first wireless access point.
